(19) United States
(12) Patent Application Publication
(10) Pub. No.: US 2023/0115576 A1
(43) Pub. Date: Apr. 13, 2023

(54) Process for Preparing a Flavored Composition

(71) Applicant: FIRMENICH SA, Satigny (CH)

(72) Inventor: Pierre-Etienne BOUQUERAND, Satigny (CH)

(21) Appl. No.: 17/905,012

(22) PCT Filed: Feb. 24, 2021
(86) PCT No.: PCT/EP2021/054509

§ 371 Date: Aug. 25, 2022

(30) Foreign Application Priority Data
Feb. 26, 2020 (EP) 20159455.3

(51) Int. Cl. A23D 7/01; A23D 7/005; A23F 3/40; A23L 2/02; A23L 27/12

(52) U.S. Cl. CPC A23D 7/011; A23D 7/0053; A23F 3/405; A23L 2/02; A23L 27/12

(57) ABSTRACT

Described herein is a process for the preparation of a flavored composition. The process provides an advantageous sustainable alternative to conventional drying (such as for example spray-drying) as it takes place at room temperature. Also described herein is a flavored composition obtainable by said process. Also described herein are consumer products including said flavored composition.

### TECHNICAL FIELD

The present invention relates to the field of delivery systems. More particularly, the invention pertains to a process for the preparation of a flavoured composition. The process of the invention provides an advantageous sustainable alternative to conventional drying (such as for example spray-drying) as it takes place at room temperature. Flavoured composition obtainable by said process is also an object of the invention. Consumer products comprising said flavoured composition are also part of the invention.

### BACKGROUND OF THE INVENTION

One of the problems faced by the flavour industry lies in the relatively rapid loss of olfactive benefit provided by active compounds due to their volatility, particularly that of “top-notes”. The encapsulation of those active substances provides at the same time a protection of the ingredients there-encapsulated against “aggressions” such as oxidation or moisture and allows, on the other hand, a certain control of the kinetics of flavour release to induce sensory effects through sequential release.

Spray-drying is part of the most common techniques used to stabilise volatile substances such as flavours by encapsulating them in a solid form, suited to many applications. Spray-drying can be used to transform a simple emulsion into a powder, therefore providing an encapsulated system in the form of a matrix, but has also been described as a suitable technique to dry microencapsulated actives in the form of aqueous slurries, in particular core-shell systems. Spray-dried powders are commonly made by spraying liquid emulsions or slurries into a stream of hot air. Spray-drying is usually done by means of a rotating disc or of multicomponent nozzles. Detailed techniques are described for instance in K. Masters, Spray-drying Handbook, Longman Scientific and Technical 1991. This drying technique suffers from several drawbacks, the main one being the temperature at which the process is performed, which necessarily leads to volatile losses during the process. Another related problem is that of technical safety, the above-described encapsulation equipment suffering from explosions of particles suspended in the air. The problem of reducing the violence of possible explosion has therefore to be addressed, e.g. by using particular fireproofing agents in formulations.

Solutions to address the problem of reducing volatile losses during spray-drying have been described, among which spray-drying at lower temperatures. WO2012/122010 describes in particular a solution based on a modification of the equipment to have an inlet temperature of less than 100° C. and an air inlet dew point comprised between −10° C. and +5° C. in order to preserve volatiles during the process. However, besides the costs generated by the equipment, this process still generates volatile losses.

On the other hand, plating is a known technique that is performed at room temperature. It refers to the immobilisation of a liquid active onto a porous carrier. The liquid is either absorbed in the particles pores and/or capillary adsorbed in-between the particles thus leading to agglomeration. This technique is processed by mixing of both liquid and powder phases into a blender which makes it the most cost-effective granulation method for oil delivery. However, plated flavours are not properly encapsulated into a shell and are therefore prone to evaporation and oxidation over storage, which limits the range of liquids that can be turned into powders by this technique to non-volatile and non-oxygen-sensitive compounds.

There is a need to find an alternative solution to existing drying techniques with the purpose of drying an emulsion on insoluble food carrier while preserving the active volatiles to be encapsulated. The present invention solves this problem by providing a new process taking place at room temperature which allows to efficiently coating a flavoured emulsion on insoluble food carrier.

### SUMMARY OF THE INVENTION

The process of the invention performed at room temperature therefore constitutes a solution to the above-mentioned problems as it allows preparing a flavoured composition while preserving the volatile ingredients there-encapsulated.

In a first aspect, the present invention relates to a process for preparing a dry flavored composition, wherein the process comprises the steps of:
a) Preparing an oil-in-water emulsion comprising:
   an oil phase comprising a flavor oil,
   a water phase comprising a water-soluble matrix material,
   optionally an emulsifier
wherein the weight ratio between the oil phase and the water phase is above 0.8, preferably above 1, more preferably above 1.5
b) Blending at room temperature the emulsion with an insoluble food carrier to obtain a dry flavoured composition,

characterized in that:
the insoluble food carrier has a water activity below 0.6, preferably below 0.5, more preferably below 0.4 and
the weight ratio between the insoluble food carrier and the emulsion is comprised between 2 and 32.

A second aspect of the invention is a flavored composition obtainable by the process as defined above.

A third aspect of the invention is a food or beverage consumer product comprising the flavored composition as defined above.

### DETAILED DESCRIPTION OF THE INVENTION

Unless stated otherwise, percentages (%) are meant to designate a percentage by weight of a composition.

By “room temperature” it is meant a temperature typically comprised between 20° C. and 30° C.

By “flavour oil”, it is meant a single flavouring compound or a mixture of several flavouring compounds.

For the sake of clarity, the expression “emulsion” in the present invention is meant to designate a system in which “particles” are dispersed in a continuous phase of a different composition and specifically includes a dispersion or a suspension. For avoidance of doubt, a capsules slurry dispersed in a water phase falls under the definition of an emulsion, as well as “free” i.e. non-encapsulated oil dispersed in a water phase, but also a mixture thereof.

“Emulsifiers” are amphiphilic molecules that concentrate at the interface between two phases and modify the properties of that interface. Examples of emulsifiers can be found in McCutcheon's Emulsifiers & Detergents or the Industrial Surfactants Handbook.

By “dry flavoured composition”, it should be understood that the flavoured composition has a water activity below 0.6, preferably below 0.5, more preferably below 0.4.

In the present invention, “flavour” and “flavor” are used indifferently.

In the present invention, “flavoured composition” and “flavored composition” are used indifferently.

The present invention provides an advantageous alternative to spray-dried powders with a process involving no heating and performed at room temperature while still providing an efficient oil encapsulation.

The present invention therefore relates in a first aspect to a process for preparing a dry flavoured composition, wherein the process comprises the steps of:
a) preparing an oil-in-water emulsion comprising:
   an oil phase comprising a flavor oil,
   a water phase comprising a water-soluble matrix material,
   optionally an emulsifier
wherein the weight ratio between the oil phase and the water phase is above 0.8, preferably above 1, more preferably above 1.5
b) blending at room temperature the emulsion with an insoluble food carrier to obtain a dry flavoured composition,

characterized in that:
the insoluble food carrier has a water activity below 0.6, preferably below 0.5, more preferably below 0.4, and
the weight ratio between the insoluble food carrier and the emulsion is comprised between 2 and 32.

According to an embodiment, in step b), the insoluble food carrier is coated with the emulsion. By “coated”, it encompasses a coating composition (made of the flavour oil, the matrix material and optionally the emulsifier) that is homogeneously coated (i.e fully coated) on the carrier but also a coating composition that is heterogeneously coated (partially coated) on the carrier.

According to an embodiment, the process described above is free of any drying step which involves water removal.

As drying step involving water removal, one may cite for example, a spray-drying step or fluidizing bed step. By contrast, the process of the present invention is devoid of any drying step involving a water removal. The emulsion used in specific ratio is simply blended with the food carrier having a given water activity to obtain a dry flavoured composition.

Indeed, step b) of the process consists in drying the emulsion obtained under step a) by blending at room temperature said emulsion with an insoluble food carrier to form a dry flavoured composition.

The blending step can be carried out by different techniques and breakage of the food carrier should be avoided. During the blending step, to form the coating, the emulsion can be poured, sprinkled or sprayed through a nozzle on the food carrier. As non-limiting examples of blending techniques, one may cite low shear blender or conical mixer.

According to a particular embodiment, when the emulsion is sprinkled or sprayed through a nozzle, the droplets size of the emulsion is greater than 0.3 mm, preferably greater than 0.5 mm.

According to another particular embodiment, the process of the invention is devoid of any spraying step.

The process according to the invention provides over traditional spray-drying the advantage of reducing possible volatile losses and respecting the initial flavour profile. It is also a way of reducing the production costs and carbon footprint, and it avoids explosion risks associated with drying liquids in hot air.

In a first step of the process, an oil-in-water emulsion is prepared. The oil phase comprises a flavour oil.

By “flavour oil” it is meant here a flavouring ingredient or a mixture of flavouring ingredients, solvent or adjuvants of current use for the preparation of a flavouring formulation, i.e. a particular mixture of ingredients which is intended to be added to an edible composition or chewable product to impart, improve or modify its organoleptic properties, in particular its flavour and/or taste. Taste modulator as also encompassed in said definition. Flavouring ingredients are well known to a skilled person in the art and their nature does not warrant a detailed description here, which in any case would not be exhaustive, the skilled flavourist being able to select them on the basis of his general knowledge and according to the intended use or application and the organoleptic effect it is desired to achieve. Many of these flavouring ingredients are listed in reference texts such as in the book by S. Arctander, Perfume and Flavor Chemicals, 1969, Montclair, N.J., USA, or its more recent versions, or in other works of similar nature such as Fenaroli's Handbook of Flavor Ingredients, 1975, CRC Press or Synthetic Food Adjuncts, 1947, by M. B. Jacobs, can Nostrand Co., Inc. Solvents and adjuvants or current use for the preparation of a flavouring formulation are also well known in the art.

In a particular embodiment, the flavour is selected from the group consisting of terpenic flavours including citrus and mint oil, and sulfury flavours.

Particular ingredients provided herein are flavors or flavor compositions particularly those flavors characterized by a logP value of 2 or more.

According to any one of the invention's embodiment, the oil represents between about 10% and 80% w/w, or even between 20% and 70% w/w, by weight, relative to the total weight of the emulsion.

According to the invention, the weight ratio between the oil phase and the water is above 0.8, more preferably above 1, more preferably above 1.5. Indeed, the viscosity of the emulsion may be greater than 500 mPa.s, preferably greater than 800 mPa.s, wherein the viscosity is measured at 25° C. with shear rate of 100 s⁻¹. The flow viscosity was measured using a TA Instruments AR2000 rheometer (New Castle, Del., USA) with concentric cylinder geometry.

According to one embodiment, flavour is in the form of a free oil dispersed in the water phase. What is meant by “free oil” in the context of the invention is an oil that is not encapsulated. According to a second embodiment, the flavour is in an encapsulated form dispersed in the water phase, i.e. in the form of a slurry. According to a third embodiment, the flavour is a mixture of free oil and encapsulated oil. When the suspension prepared in the first step of the invention comprises oil in an encapsulated form, the latter preferably consists of water-insoluble microcapsules. Those microcapsules can be obtained by any process known in the art and do not necessitate a more detailed description. As non-limiting examples, those water-insoluble microcapsules can be obtained by a process selected from the group consisting of interfacial polymerisation, polycondensation, simple and complex coacervation or a combination thereof. According to a particular embodiment the microcapsules have a core-shell structure with a polymeric shell. The nature of the polymeric shell from the microcapsules of the invention can vary.

According to another embodiment, the microcapsules have a polymeric shell resulting from complex coacervation wherein the shell is possibly cross-linked such as described in WO2014044840 or WO2013174921.

According to an embodiment, the emulsion comprises dry flavoring ingredients that are well known by the person skilled in the art.

The oil phase is dispersed in a water phase including a water-soluble matrix material.

Said water-soluble matrix material (carrier) is preferably present in an amount comprised between 10 wt % and 60 wt %, preferably between 15 and 57% by weight of the emulsion. Carrier: The matrix material used in the present invention is water soluble. A “water soluble matrix material” is intended for the purpose of the present invention as encompassing any carrier which forms a one-phase solution in water. Preferably, it forms a one phase solution when dissolved in water at concentrations as high as 20% by weight, more preferably even as high as 50% by weight. Most preferably it forms a one phase solution when dissolved in water at any concentration.

As non-limiting examples, maltodextrin, modified starch, inulin, plant-based proteins such as pea protein, soluble flours, gums such as Gum Arabic, soluble fibers, soluble polysaccharides, and mixtures thereof can be used as matrix material.

According to a particular embodiment, the water-soluble matrix material is a modified starch or octenylsuccinated starch.

According to a particular embodiment, the water-soluble matrix material is Gum Arabic.

According to a particular embodiment, the water-soluble matrix material does not comprise starches.

The term “soluble fiber” as used herein refers to polysaccharides characterized as being soluble by using the official method of the Association of Official Analytical Chemists (Prosky et al, 1988; J. Assoc. Off Anal. Chem, 70, 5, 1017), e.g. water soluble fibers, e.g. water soluble at room temperature. Said soluble fiber may be for example fruit fiber, grain fibers, natural soluble fibers and synthetic soluble fibers. Natural fibers include Soluble Corn Fiber, maltodextrin, acacia and hydrolyzed guar gum. Synthetic soluble fibers include polydextrose, modified food starch, and similar. Food grade sources of soluble fiber useful in embodiments of the present invention include inulin, corn fiber, barley, corn germ, ground oat hulls, milled corn bran, derivatives of the aleurone layer of wheat bran, flax flour, whole flaxseed bran, winter barley flake, ground course kilned oat groats, maize, pea fiber (e.g. Canadian yellow pea) Danish potatoes, konjac vegetable fiber, psylliumfiber from seed husks of planago ovate, psyllium husk, liquid agave fiber, rice bran, oat sprout fibers, amaranth sprout, lentil flour, grape seed fiber, apple, blueberry, cranberry, fig fibers, ciranda power, carob powder, milled prune fiber, mango fiber, apple fiber, orange, orange pulp, strawberry, carrageenan hydrocolloid, derivatives of eucheuma cottonnil seaweed, cottonseed, soya, kiwi, acacia gum fiber, bamboo, chia, potato, potato starch, pectin (carbohydrate) fiber, hydrolyzed guar gum, carrot, soy, soybean, chicory root, oat, wheat, tomato, polydextrose fiber, refined corn starch syrup, isomalto-oligosaccharide mixtures, soluble dextrin, mixtures of citrus bioflavonoids, cell-wall broken nutritional yeast, lipophilic fibers, plum juice, derivatives from larch trees, olygose fibers, derivatives from cane sugar, short-chain fructooligosaccharides, synthetic polymers of glucose, polydextrose, pectin, polanion compounds, cellulose fibers, cellulose fibers derived from hard wood plants and carboxymethyl cellulose.

According to a particular embodiment, the matrix material has emulsifying properties such as Gum Arabic. In this particular embodiment, the emulsifier is optional.

According to another embodiment, the emulsion further comprises an emulsifier. Typical emulsifiers include lecithin, glycerol esters, fatty acid esters, saponins, proteins, gum Arabic and mixtures thereof, preferably in an amount comprised between 0.5 and 25%, preferably between 2 and 25% by weight based on the total weight of the emulsion.

According to a particular embodiment, the emulsifier and the water soluble matrix material are different materials.

In a second step of the process of the invention, the emulsion obtained under step a) is blended at room temperature with an insoluble food carrier.

According to the invention, the insoluble food carrier has a water activity below 0.6 preferably below 0.5, even more preferably below 0.4.

Water activity is a well-known parameters of expressing how much free water exists in a water-containing composition.

Water activity (aw) is the partial vapor pressure of water in a substance divided by the standard state partial vapor pressure of water. In the field of food science, the standard state is most often defined as the partial vapor pressure of pure water at the same temperature.

The water activity a_{w} is defined as follows p/p*

where p is the partial vapor pressure of water in the solution, and p* is the partial vapor pressure of pure water at the same temperature.

Aw is an intrinsic properties of a composition can be easily determined by different methods such as resistive electrolytic, a capacitance or a dew point hygrometer.

Water activity has been determined at 25° with a Rotronic Hygrolab cell with four decimal digit and calibrated with saturated salt solutions, USING SUPPLIER Quick Aw® function estimating Aw after 5 to 6 min equilibration.

According to a particular embodiment, the food carrier has a water activity below the critical water activity of water-soluble matrix material, wherein the flavored composition after equilibration has still a water activity below the critical water activity of water-soluble matrix and the glass transition temperature of the flavored composition is equal or higher than 25° C. Critical water activity of water-soluble matrix (for example polysaccharides) a_{w}* has been defined by several authors as the a_{w} at which sufficient moisture is present to yield a glass transition value of 25° C. This practical metric of the hygroscopic stability of carbohydrate glasses can be measured or even predicted (M. Sillick, C. M. Gregson/Carbohydrate Polymers 79 (2010) 1028-1033).

According to a particular embodiment, the insoluble food carrier is used in an amount such that the weight ratio between the insoluble food carrier and the emulsion is comprised 2 and 32, preferably between 2.3 and 19, preferably between 2.6 and 9

The insoluble food carrier may be chosen in the group consisting of tea, coffee, herbal carrier, fruit carrier, flowers, leaves, beans/seeds, and other botanicals.

The insoluble food carrier may be in the form of leaves, in particular whole leaves, cut leaves, ground leaves, powders, in particular free-flowing powders, or particles.

A second object of the invention consists of a flavored composition obtainable by a process as described in any of the above-described embodiments

The flavored composition according to the invention, present an advantageous alternative to spray-dried powder as they ensure an optimal preservation of the profile from flavour there-encapsulated.

According to an embodiment, the flavored composition has a flavor oil loading greater than 1%, preferably greater than 3%, more preferably greater than 8%, even more preferably greater than 10%, even more preferably greater than 12% by weight based on the total weight of the flavored composition.

Another object of the present invention is a flavored consumer product comprising the flavored composition of the present invention. Preferably, the flavoured product is a food product or a beverage.

Typical food products are selected from the group consisting of an instant soup or sauce, a breakfast cereal, a powdered milk, a baby food, a powdered drink, a powdered chocolate drink, a spread, a powdered cereal drink, a chewing gum, an effervescent tablet, a cereal bar, and a chocolate bar. The powdered foods or drinks may be intended to be consumed after reconstitution of the product with water, milk and/or a juice, or another aqueous liquid.

The dry flavored composition provided herein may be suitable for conveying flavors to beverages, fluid dairy products, condiments, baked goods, frostings, bakery fillings, candy, chewing gum and other food products.

Beverages include, without limitation, powdered drinks, as well as liquid concentrates such as fountain syrups and cordials; hot beverages including malt drinks, cocoa, coffee and coffee-based drinks, coffee substitutes and cereal-based beverages; instant beverages, teas, including dry mix products as well as ready-to-drink teas (herbal and tealeaf based); fruit and vegetable juices and juice flavored beverages as well as juice drinks, nectars, concentrates, the dry flavored mouth care products or pharmaceutical products.

As non-limiting examples, the flavored consumer product is in the form of a
Baked goods (e.g. bread, dry biscuits, cakes, other baked goods),
Instant beverages (e.g. hot drinks, instant vegetable drinks, powdered soft drinks, instant coffee and tea, chocolate drinks, malt drinks),
Cereal products (e.g. breakfast cereals, pre-cooked ready-made rice products, rice flour products, millet and sorghum products, raw or pre-cooked noodles and pasta products),
condensed milk and analogues,
Confectionary products (e.g. chewing gum, hard and soft candy)
Chocolate and compound coatings
Dried egg
Vegetarian meat replacer, vegetarian burger
Spices or spice preparations (e.g. mustard preparations, horseradish preparations), spice mixtures and, in particular seasonings which are used, for example, in the field of snacks.
Snack articles (e.g. baked or fried potato crisps or potato dough products, bread dough products, extrudates based on maize, rice or ground nuts).

According to a particular embodiment, the consumer product comprising the flavored composition is in the form of hot or cold beverages such as herbal infusions, coffee, tea, botanicals.

According to a preferred embodiment, the flavored consumer product comprises the flavored composition according to the present invention in an amount between 0.8% and 100%, preferably between 1% and 50%, and most preferably between 1.5% and 20% based on the total weight of the flavored consumer product.

A further object of the present invention is a method of preparing the flavored consumer product, preferably a food product or a beverage, wherein the method comprises the following steps:
a. providing a consumer product, preferably a food product or beverage,
b. adding the flavored composition of the present invention to the consumer product, preferably a food product or beverage.

The consumer product, preferably food product or beverage, to which the flavor composition may be added is a (flavored) consumer product, preferably food product or beverage, as described herein above without the flavor composition of the present invention.

The consumer product, preferably food product or beverage, may be flavored before adding the flavor composition of the present invention or may be not flavored.

The flavored composition may be added to the consumer product by any means of addition known by a person skilled in the art such as for example, but not limited to, conveying, mixing, coating, infusion or the like.

The invention will now be further described by way of examples. It will be appreciated that the invention as claimed is not intended to be limited in any way by these examples.

### EXAMPLES

### Example 1 Preparation of a Flavored Composition According to the Invention

A solution is made by dissolving 25 g of HiCap100™ (Octenly succinated starch—Ingredion) in 25 g of tapped water. 50 g of lemon flavor are dispersed slowly into the solution using a propeller head mixer and/or a rotor stator mixer (Turrax™ IKA). The created emulsion has a viscosity greater than 600 mPa.s and its flavor content is about 50%. Flavor/water ratio is about 2.

17 g of previous emulsion are slowly poured on 83 g of tea leaves containing 6% water resulting in a water activity of 0.4. During the addition the tea blend is gently mixed with a spoon to obtain an homogeneous blend without aggregation. The water activity of the blend containing the emulsion measured with Rotronic Hygrolab cell is 0.57. The flavor load of the resulting coated tea-leaves is about 8% ww.

### Example 2 Preparation of a Flavored Composition According to the Invention (High Flavor Load)

A solution is made by dissolving 15 g of HiCap100™ (Octenly succinated starch—Ingredion) in 15 g of tapped water. 70 g of lemon flavor are dispersed slowly into the solution using a propeller head mixer and/or a rotor stator mixer (Turrax™ IKA). The created emulsion has a viscosity greater than 1000 mPa.s and its flavor content is about 70%. Flavor/water ratio is about 4.7.

20 g of previous emulsion are slowly poured on 80 g of tea leaves containing 6% water resulting in a water activity of 0.4. During the addition the tea blend is gently mixed with a spoon to obtain an homogeneous blend without aggregation. The water activity of the blend containing the emulsion measured with Rotronic Hygrolab cell is 0.58. The flavor load of the resulting coated tea-leaves is about 14% ww.

### Example 3 Preparation of a Flavored Composition According to the Invention

A solution is made by dissolving 19 g of Gum acacia in 43 g of tapped water. 38 g of lemon flavor are dispersed slowly into the solution using a propeller head mixer and/or a rotor stator mixer (Turrax™ IKA). The emulsification step should be progressive to avoid phase inversion. The created emulsion has a viscosity greater than 1000 mPa.s and its flavor content is about 38%. Flavor/water ratio is about 0.9.

5 g of previous emulsion are slowly poured on 95 g of tea leaves containing 6% water resulting in a water activity of 0.4. During the addition the tea blend is gently mixed with a spoon to obtain an homogeneous blend without aggregation. The water activity of the blend containing the emulsion measured with Rotronic Hygrolab cell is 0.57. The flavor load of the resulting coated tea-leaves is only about 2% ww.

### Example 4 Preparation of a Flavored Composition According to the Invention

A solution is made by dissolving 57 g of 47 DE corn syrup (Glucidex 47 DE Roquette) in 19 g of tapped water. 2 g of soy lecithin are dispersed into 10 g of lemon flavor. The resulting blend is dispersed slowly into the solution using a propeller head mixer. Then additional 12 g of the same flavor are slowly dispersed into the previous emulsion using a rotor stator mixer (Turrax™ IKA). The created emulsion has a viscosity>1000 mPa.s and its flavor content is about 22%. Flavor/water ratio is about 1.2.

15 g of previous emulsion are slowly poured on 75 g of tea leaves containing 6% water resulting in a water activity of 0.4. During the addition the tea blend is gently mixed with a spoon to obtain an homogeneous blend without aggregation. The water activity of the blend containing the emulsion measured with Rotronic Hygrolab cell is 0.52. The flavor load of the resulting coated tea-leaves is about 3% ww.

### Example 5 Preparation of a Flavored Composition Outside the Scope of the Invention

A solution is made by dissolving 40 g of HiCap100™ (Octenly succinated starch—Ingredion) in 40 g of tapped water. 20 g of lemon flavor are dispersed slowly into the solution using a propeller head mixer and/or a rotor stator mixer (Turrax™ IKA). The created emulsion has a viscosity>230 mPa.s and its flavor content is about 20%. Flavor/water ratio is about 0.5.

20 g of previous emulsion are slowly poured on 80 g of tea leaves containing 6% water resulting in a water activity of 0.4. During the addition the tea blend is gently mixed with a spoon to obtain an homogeneous blend without aggregation. The water activity of the blend containing the emulsion measured with Rotronic Hygrolab cell is 0.96. As a result, the obtained flavored composition is too wet to guaranty its physical and microbial stability and to avoid flavor losses during storage. The flavor load of the resulting coated tea-leaves is about 4% ww.

1. A process for preparing a dry flavored composition, wherein the process comprises the steps of:
a) preparing an oil-in-water emulsion comprising:
an oil phase comprising a flavor oil,
a water phase comprising a water-soluble matrix material, and
optionally, an emulsifier,
wherein a weight ratio between the oil phase and the water phase is above 0.8, and
b) blending at room temperature the emulsion with an insoluble food carrier to obtain a dry flavoured composition,
wherein:
the insoluble food carrier has a water activity below 0.6, and
a weight ratio between the insoluble food carrier and the emulsion is between 2 and 32.

2. The process according to claim 1, wherein the process does not comprise a spray-drying step.

3. The process according to claim 1, wherein the flavor oil in the emulsion is freely dispersed in the water phase.

4. The process according to claim 1, wherein in the emulsion, one part of the flavor oil is freely dispersed in the water phase and another part of the flavor oil is dispersed in an encapsulated form in the water phase.

5. The process according to claim 1, wherein the flavor oil is dispersed in the emulsion in an encapsulated form in the water phase.

6. The process according to claim 1, wherein the oil-in-water emulsion has a viscosity greater than 500 mPa.s, wherein the viscosity is measured at 25° C. with a shear rate of 100 s⁻¹.

7. The process according to claim 1, wherein the water-soluble matrix is selected from the group consisting of maltodextrin, modified starch, inulin, plant-based proteins, gums, soluble fibers, soluble polysaccharides, and mixtures thereof.

8. The process according to claim 1, wherein the emulsifier is selected from the group consisting of lecithin, glycerol esters, fatty acid esters, saponins, proteins, gum Arabic, octenyl succinated starch, and mixtures thereof.

9. The process according to claim 1, wherein the emulsion comprises:
between 10 and 80% by weight of the oil phase,
between 10 and 60% by weight of the water-soluble matrix material,
optionally between 0.5 and 25% by weight of the emulsifier,
based on a total weight of the emulsion.

10. The process according to claim 1, wherein the insoluble food carrier is selected from the group consisting of tea, coffee, herbal carrier, fruit carrier, flowers, leaves, beans, seeds, and other botanicals.

11. The process according to claim 10, wherein the insoluble food carrier is tea.

12. A flavored composition obtainable by the process according to claim 1.

13. The flavored composition according to claim 12, wherein a flavor oil loading is greater than 10% by weight based on a total weight of the flavored composition.

14. A food or beverage consumer product comprising the flavored composition according to claim 12, wherein the food or beverage consumer product is selected from the group consisting of a beverage, a sweet good, and a savory good.

15. The consumer product according to claim 14, wherein the consumer product is in the form of hot or cold beverages.

16. A food or beverage consumer product comprising the flavored composition according to claim 13, wherein the food or beverage consumer product is selected from the group consisting of a beverage, a sweet good, and a savory good.

17. The consumer product according to claim 16, wherein the consumer product is in the form of hot or cold beverages.

18. The process according to claim 1, wherein the process comprises the steps of:
a) preparing an oil-in-water emulsion comprising:
an oil phase comprising a flavor oil,
a water phase comprising a water-soluble matrix material, and
optionally, an emulsifier,
wherein a weight ratio between the oil phase and the water phase is above 1, and
b) blending at room temperature the emulsion with an insoluble food carrier to obtain a dry flavoured composition,
wherein:
the insoluble food carrier has a water activity below 0.6, and
a weight ratio between the insoluble food carrier and the emulsion is between 2 and 32.

19. The process according to claim 1, wherein the process comprises the steps of:
a) preparing an oil-in-water emulsion comprising:
an oil phase comprising a flavor oil,
a water phase comprising a water-soluble matrix material, and
optionally, an emulsifier,
wherein a weight ratio between the oil phase and the water phase is above 0.8, and
b) blending at room temperature the emulsion with an insoluble food carrier to obtain a dry flavoured composition,
wherein:
the insoluble food carrier has a water activity below 0.5, and
a weight ratio between the insoluble food carrier and the emulsion is between 2 and 32.

20. The process according to claim 1, wherein the oil-in-water emulsion has a viscosity greater than 800 mPa.s, wherein the viscosity is measured at 25° C. with a shear rate of 100 s⁻¹.
